(19) United States
(12) Patent Application Publication
(10) Pub. No.: US 2007/0162409 A1
(43) Pub. Date: Jul. 12, 2007

(54) Creation and maintenance of ontologies

(76) Inventors: Kurt S. Godden, Sterling Heights, MI (US); John A. Cafeo, Farmington, MI (US); Ronald M. Lesperance, Troy, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/327,116

(22) Filed: Jan. 6, 2006

(51) Int. Cl. G06N 5/02

(52) U.S. Cl. 706/48

(57) ABSTRACT

A method for creating and maintaining ontologies. The method includes transmitting a two dimensional table to a requestor. The table includes domain concepts and semantic primitives related to a domain. A data value in the table at an intersection of a domain concept and a semantic primitive indicates that the domain concept is characterized by the semantic primitive. A command to modify the table is received from the requestor. The table is updated in response to the command. The updated table is stored as an ontology.

### BACKGROUND OF THE INVENTION

The present disclosure relates generally to ontologies and in particular, to the creation and maintenance of ontologies.

An ontology is a formal description of concepts and their interrelationships within some domain and is typically used by a software application (e.g., to provide a smart search capability). The primary semantic relation captured in an ontology is that of class-subclass relations, usually called subsumption. For example, the more general concept of “vehicle” subsumes the subclass “truck.” This relationship is usually represented either as a set-subset relation, perhaps with a Venn diagram, or as a subsumption tree where a parent node (e.g., “vehicle”) represents the more general concept and the child nodes (e.g., “truck”) their subclasses.

Ontologies are generally defined by a trained knowledge engineer who understands the complexities of conceptual semantics. The trained knowledge engineer utilizes specialized development packages (e.g., Protégé) and languages (e.g., Resource Description Format (RDF) and Web Ontology Language (OWL)) to define an ontology. The trained knowledge engineer consults with a domain expert in order to properly understand and represent the concepts in the domain of interest. Thus, ontology development is a time-consuming and costly activity. Further, this high-cost activity continues indefinitely since an ontology must be maintained over time in order to capture new concepts and include them into the existing, interconnected framework initially developed.

### BRIEF DESCRIPTION OF THE INVENTION

One aspect of the invention is a method for creating and maintaining an ontology. The method includes transmitting a two dimensional table to a requestor. The table includes domain concepts and semantic primitives related to a domain. A data value in the table at an intersection of a domain concept and a semantic primitive indicates that the domain concept is characterized by the semantic primitive. A command to modify the table is received from the requestor. The table is updated in response to the command. The updated table is stored as an ontology.

In another aspect, a system for creating and maintaining an ontology includes an output mechanism for transmitting a two dimensional table to a requestor. The table includes domain concepts and semantic primitives related to a domain. A data value in the table at an intersection of a domain concept and a semantic primitive indicates that the domain concept is characterized by the semantic primitive. The system also includes an input mechanism for receiving a command from the requester to modify the table. The system further includes a processor in communication with the input mechanism and the output mechanism. The processor includes instructions for facilitating updating the table in response to the command and storing the updated table as an ontology.

In a further aspect, a computer program product for creating and maintaining an ontology includes a storage medium readable by a processing circuit and storing instructions for execution by the processing circuit for performing a method. The method includes transmitting a two dimensional table to a requestor. The table includes domain concepts and semantic primitives related to a domain. A data value in the table at an intersection of a domain concept and a semantic primitive indicates that the domain concept is characterized by the semantic primitive. A command to modify the table is received from the requester. The table is updated in response to the command. The updated table is stored as an ontology.

### BRIEF DESCRIPTION OF THE DRAWINGS

Referring to the exemplary drawings wherein like elements are numbered alike in the several FIGURES:

FIG. 1 is a two dimensional table with semantic primitives along one axis and domain concepts on the other axis that may be utilized by exemplary embodiments;

FIG. 2 is a flow diagram of an exemplary ontology creation and maintenance process;

FIG. 3 is a user interface that may be utilized by exemplary embodiments to add a new domain concept to a table; and

FIG. 4 is a block diagram of an exemplary system for creating and maintaining ontologies.

### DETAILED DESCRIPTION OF THE INVENTION

Exemplary embodiments provide for the creation of a base ontology by trained knowledge engineers, but without using specialized ontology software and languages. In addition, the ontology may be maintained by domain experts, or end users. The domain experts do not require training in the specialized ontology software and languages to maintain the ontology. Exemplary embodiments provide a representational framework and development tool to allow the domain experts to maintain the ontology without being trained in ontology engineering.

In a subsumption relationship, the parent/containing concept represents a fundamental semantic notion, a “semantic primitive,” that the subsumed concept possesses, in some sense. Thus, it could be said that the concept “truck” possesses the feature “vehicle.” It possesses other features as well, but “truck” could be distinguished from “car”, for example if all of the features possessed by each were listed, with at least one feature listed with one concept but not the other. This observation leads to a new method for creating ontologies without the use of specialized software.

In exemplary embodiments, the creation of a base ontology entails the following steps by trained knowledge engineers, but without using specialized ontology software. The domain of vehicle assembly is utilized herein to illustrate the following examples, but the processes described herein may be applied to any domain. First, a trained knowledge engineer determines relevant domain concepts (e.g,. concept “A-gap” in an assembly plant body shop). Next, a set of semantic primitives that characterize the entire set of domain concepts uniquely is determined. A semantic primitive is a basic descriptor (e.g., A-gap has the descriptors: surface, misalignment, gap, and orientation). A table is then created that has the semantic primitives along one axis and the domain concepts on the other axis. Finally, each semantic primitive that applies to each domain concept is marked with a data value (e.g., “X”) at the intersection of the semantic primitive and applicable domain concept.

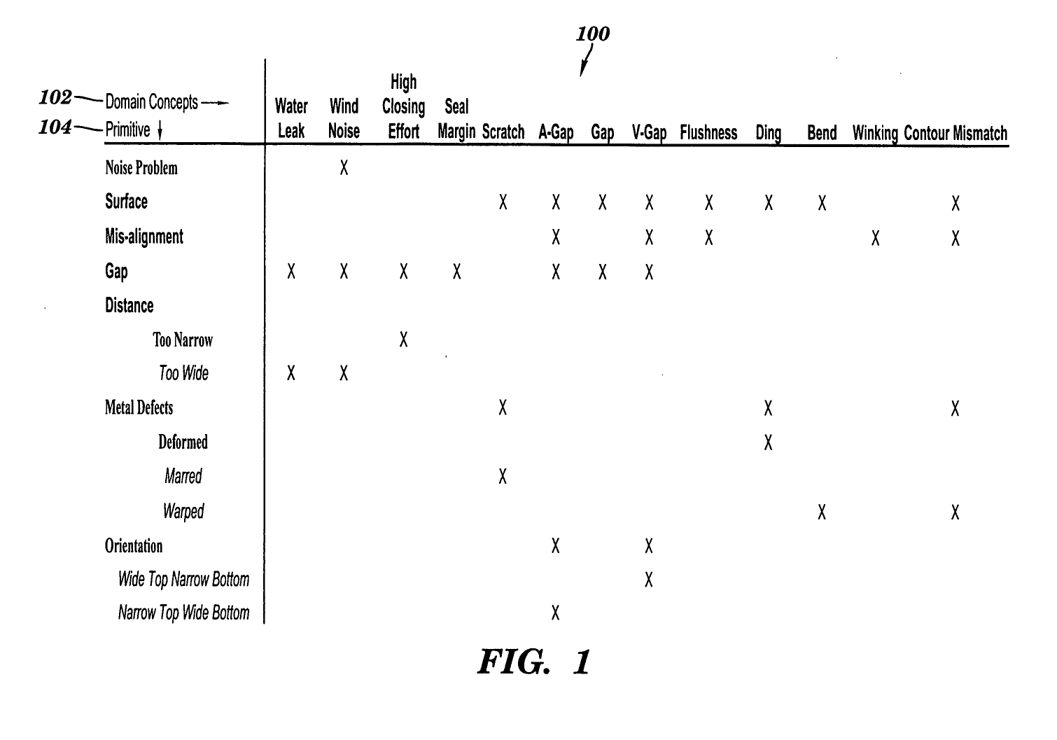

FIG. 1 is an exemplary two dimensional table 100 with semantic primitives 104 along one axis and domain concepts 102 on the other axis. It represents a sample table 100 that may be utilized for the domain of vehicle assembly. The example domain concepts 102 include: water leak, wind noise, high closing effort, seal margin, scratch, A-gap, gap, V-gap, flushness, ding, bend, winking and contour mismatch. The example semantic primitives 104 include: noise problem, surface, mis-alignment, gap, distance (too narrow, too wide), metal defects (deformed, marred, warped), and orientation (wide top narrow bottom, narrow top wide bottom). The data value “X” at the intersection of wind noise and noise problem means that the domain concept wind noise is characterized by the semantic primitive noise problem. Also, as shown in FIG. 1, the domain concept wind noise is also characterized by the semantic primitives gap and a too wide distance.

Each domain concept 102 is uniquely determined by the semantic primitives 104 that characterize it. By using binary (e.g., surface) or symbolic-valued (e.g., distance=too narrow or too wide) semantic primitives, a domain ontology can be deployed that will permit maintenance to be performed by end-users through a simple graphical user interface. In exemplary embodiments, the matrix (or table 100) depicted in FIG. 1 is translated to a set of domain concepts 102 with labeled check boxes and radio buttons that represent the semantic primitives 104. This allows users to enter new domain concepts 102 into the ontology without being trained in knowledge engineering. The users need only check various check boxes or radio buttons until the new concept is uniquely characterized (i.e., the checked/highlighted boxes and buttons can distinguish the new domain concept 102 from all other domain concepts 102) in the same way that each column in the table 100 in FIG. 1 is different from every other column. In alternate embodiments, the table 100 is stored in a commercially available spreadsheet and is updated via the spreadsheet tool.

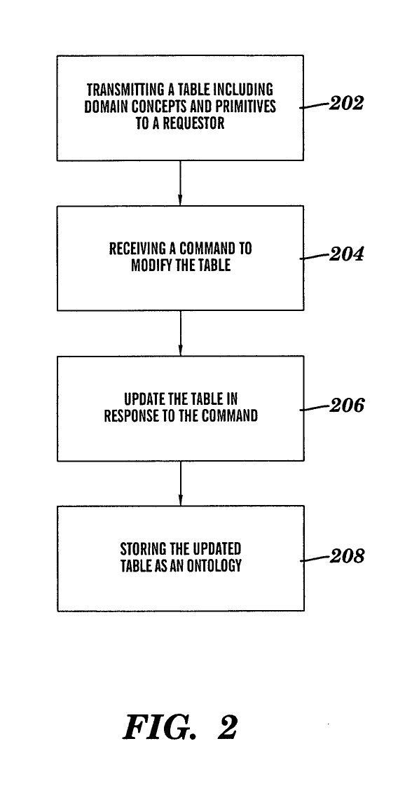

FIG. 2 is a flow diagram of an exemplary ontology creation and maintenance process. The process depicted in FIG. 2 may be implemented by an ontology creation and maintenance application program. At block 202, a table 100 is transmitted to a requester (e.g., via a network). The table 100 is a two dimensional table that includes domain concepts 102 and semantic primitives 104 related to a domain (e.g., vehicle assembly). As discussed above in reference to FIG. 1, a data value (e.g. “X”) at an intersection of a domain concept 102 and a semantic primitive 104 indicates that the domain concept 102 is characterized by the semantic primitive 104. In exemplary embodiments, the transmitting includes transmitting a user interface screen to the requester. The user interface screen is displayed on a user system and is utilized to display the table 100 and to allow the requester to input commands to modify the table 100. As described previously, the user interface screen may be a graphical user interface (GUI) including boxes and buttons to be selected by the requester, or user, to create commands for modifying the table 100. The requestor/user may add and/or delete “X's” from the table 100 via a GUI interface, with each of the add and/or deletes getting translated into a command to modify the table 100.

At block 204, a command to modify the table 100 is received (e.g., via the network) from the requestor and at block 206 the table 100 is updated in response to the command. The command may indicate that a selected domain concept 102 is characterized by a selected semantic primitive 104. As a result of the command, the table 100 is updated to add the data value (e.g., “X”) at the intersection of the selected domain concept 102 and the selected semantic primitive 104. Alternatively, the command may indicate that a selected domain concept 102 is no longer characterized by a selected semantic primitive 104. As a result of the command, the table 100 is updated to remove the data value (e.g., “X”) at the intersection of the selected domain concept 102 and the selected semantic primitive 104.

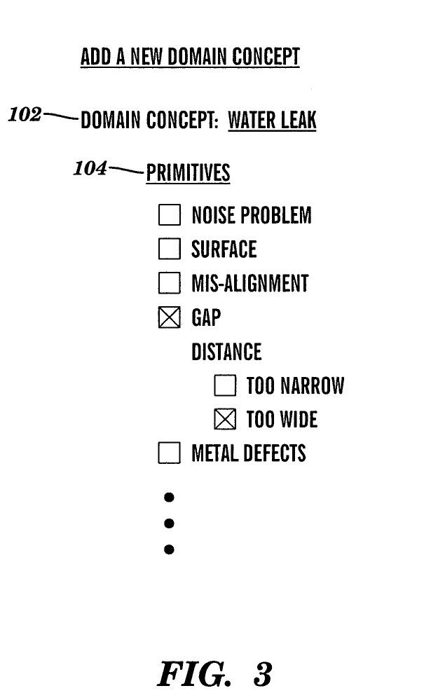

The command could also specify that a new domain concept 102 or a new semantic primitive 104 should be added to the table 100. See FIG. 3 for an exemplary user interface for adding a new domain concept 102 to the table 100. Other commands could specify that an existing domain concept 102 or semantic primitive 104 is no longer required and would result in a row or column being deleted from the table. In general, deletion of domain concepts 102 and semantic primitives 104 should be performed by trained knowledge engineers who can assess the impact of the deletion on the domain.

In exemplary embodiments, the updating in block 206 is performed only if the updating will result in all of the domain concepts 102 in the updated table being uniquely characterized by one or more semantic primitives 104. The requestor is alerted to possible errors in a proposed modification via standard GUI methods (e.g., use of color and sound). Depending on the implementation requirement, the requestor may just be warned of possible errors or could be prevented from making the changes that would result in the errors. In addition, a requester may be prevented (or warned) from deleting a semantic primitive 104 that is being used to characterize one or more domain concepts 102.

At block 208, the updated table 100 is stored as an ontology. The ontology may be stored as a two dimensional table or the storing may include converting the table into another ontology format. In exemplary embodiments, the ontology is represented as a directed graph or as a hierarchical graph. In exemplary embodiments, the ontology is stored in a format that is compatible with a specialized ontology language (e.g., RDF and OWL) for further editing and/or for input into a specialized ontology development package (e.g., Protégé). In exemplary embodiments, the ontology is used for providing a smart search capability. For example, the ontology may be utilized to identify similar problem/solution pairs in a problem reporting system based on the words utilized to describe a problem. The semantic primitives 104 could be utilized to categorize the domain concepts 102 in order to pull up related problems.

FIG. 3 is a user interface that may be utilized by exemplary embodiments to add a new domain concept 102 to the table 100. The user interface includes a space for adding the name of the new domain concept 102 and lists all the semantic primitives 104 currently in the table 100. The requestor/user may then select which semantic primitives 104 should be applied to the new domain concept 102. The intersection of the selected semantic primitives 104 and the new domain concept 102 are marked with a data value (e.g., “X”) to indicate that the semantic primitives 104 are related to the domain concept 102. An alternate user interface includes the entire table 100 with an input box on the far right for adding a new column for adding a new domain concept 102. The user then selects the semantic primitives 104 by entering a data value (e.g., an “X”) into the rows corresponding to the semantic primitives 104 that correspond the to the new domain concept 102. As described previously, a verification may be performed to insure that the new domain concept 102 is uniquely characterized by the selected semantic primitives 104.

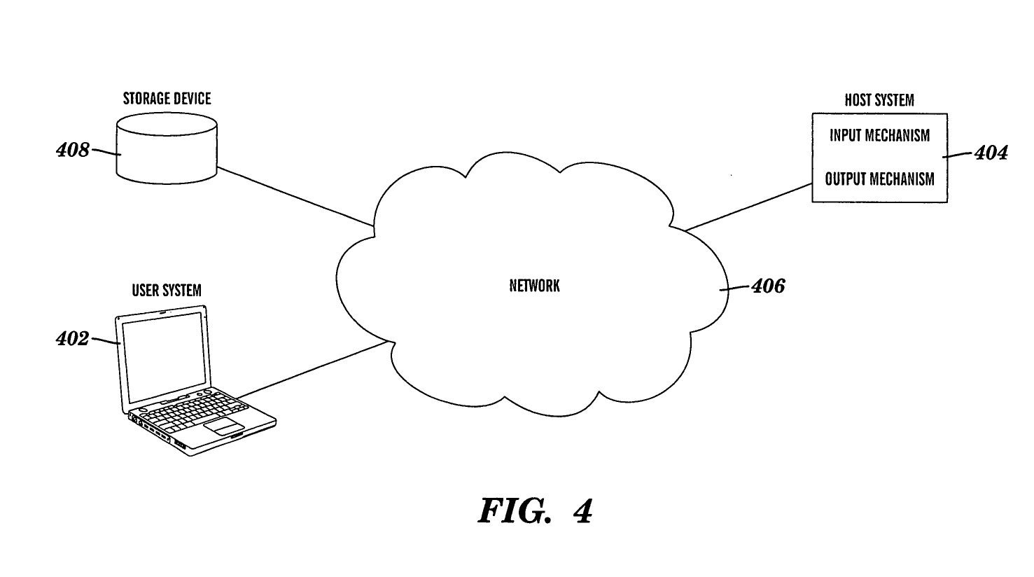

FIG. 4 is a block diagram of an exemplary system for creating and maintaining ontologies. The system includes one or more user systems 402 through which users/requestors at one or more geographic locations may contact the host system 404 to create and maintain ontologies. In exemplary embodiments, the host system 404 executes the ontology creation and maintenance application program and the user systems 402 are coupled to the host system 404 via a network 406. The host system 404 includes an input mechanism for receiving data, an output mechanism for transmitting data, and a processor for executing computer instructions. Each user system 402 may be implemented using a general-purpose computer executing a computer program for carrying out the processes described herein. The user systems 402 may be personal computers (e.g., a lap top, a personal digital assistant) or host attached terminals. If the user systems 402 are personal computers or have the processing capabilities required, the processing described herein may be shared by a user system 402 and the host system 404 (e.g., by providing an applet to the user system 402).

The network 406 may be any type of known network including, but not limited to, a wide area network (WAN), a local area network (LAN), a global network (e.g. Internet), a virtual private network (VPN), and an intranet. The network 406 may be implemented using a wireless network or any kind of physical network implementation known in the art. A user system 402 may be coupled to the host system through multiple networks (e.g., intranet and Internet) so that not all user systems 402 are coupled to the host system 404 through the same network. One or more of the user systems 402 and the host system 404 may be connected to the network 406 in a wireless fashion. In exemplary embodiments, the network is an intranet and one or more user systems 402 execute a user interface application (e.g. a web browser) to contact the host system 404 through the network 406 while another user system 402 is directly connected to the host system 404. In other exemplary embodiments, the user system 402 is connected directly (i.e., not through the network 406) to the host system 404 and the host system 404 is connected directly to or contains the storage device 408. In other exemplary embodiments, the user system 402 includes a stand-alone application program to perform ontology creation and maintenance, as well as the application data such as the table 100. In this embodiment, the application program and data are updated on a periodic basis.

The storage device 408 may be implemented using a variety of devices for storing electronic information. It is understood that the storage device 408 may be implemented using memory contained in the host system 404 or it may be a separate physical device. The storage device 408 is logically addressable as a consolidated data source across a distributed environment that includes a network 406. Information stored in the storage device 408 may be retrieved and manipulated via the host system 404. The storage device 408 includes one or more tables 100, and ontologies (e.g., ontology databases). The storage device 408 may also include other kinds of data such as information concerning the updating of the table 100 (e.g., a user identifier, date, and time of update). In exemplary embodiments, the host system 404 operates as a database server and coordinates access to application data including data stored on storage device 408.

The host system 404 depicted in FIG. 4 may be implemented using one or more servers operating in response to a computer program stored in a storage medium accessible by the server. The host system 404 may operate as a network server (e.g., a web server) to communicate with the user system 402. The host system 404 handles sending and receiving information to and from the user system 402 and can perform associated tasks. The host system 404 may also include a firewall to prevent unauthorized access to the host system 404 and enforce any limitations on authorized access. For instance, an administrator may have access to the entire system and have authority to modify portions of the system. A firewall may be implemented using conventional hardware and/or software as is known in the art.

The host system 404 may also operate as an application server. The host system 404 executes one or more computer programs to perform ontology creation and maintenance functions. Processing may be shared by the user system 402 and the host system 404 by providing an application (e.g., java applet) to the user system 402. Alternatively, the user system 402 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

Exemplary embodiments allow maintenance of ontologies to be performed by knowledgeable end users who do not need to be conversant in specialized ontology development packages or languages. Exemplary embodiments represent ontologies as two dimensional tables with domain concepts 102 on one axis and semantic primitives 104 on the other axis. Most end users are knowledgeable in the use/interpretation of two-dimensional tables or spreadsheets to represent data and relationships between the data. The use of tables to represent ontologies eliminates the need for a knowledge engineer to be required for updating the ontology on a continuous basis. The only time during routine maintenance when a knowledge engineer may need to be brought back into the process would be when a new domain concept 102 is introduced that cannot be uniquely distinguished from the other domain concepts 102 using existing semantic primitives 104. In other words, there is a need for a new semantic primitive 104 to be introduced into the table as a new row.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for creating and maintaining an ontology, the method comprising:
transmitting a two dimensional table to a requestor, the table including domain concepts and semantic primitives related to a domain, wherein a data value in the table at an intersection of a domain concept and a semantic primitive indicates that the domain concept is characterized by the semantic primitive;
receiving a command to modify the table from the requester;
updating the table in response to the command; and
storing the updated table as an ontology.

2. The method of claim 1 further comprising transmitting a user interface screen for displaying the table to the requester, wherein the command is received via the requester selecting an option on the user interface screen.

3. The method of claim 1 wherein the command indicates that a selected domain concept is characterized by a selected semantic primitive and the updating includes adding the data value in the table at an intersection of the selected domain concept and the selected semantic primitive.

4. The method of claim 1 wherein the command indicates that a selected domain concept is no longer characterized by a selected semantic primitive and the updating includes removing the data value in the table at an intersection of the selected domain concept and the selected semantic primitive.

5. The method of claim 1 wherein the command includes adding one or more of a new domain concept and a new semantic primitive to the table.

6. The method of claim 1 wherein the ontology is represented as a directed graph.

7. The method of claim 1 wherein the ontology is represented as a hierarchical graph.

8. The method of claim 1 wherein the ontology is compatible with a specialized ontology language.

9. The method of claim 1 further comprising importing the ontology into a specialized ontology development package.

10. The method of claim 1 wherein the ontology is utilized to provide a smart search capability.

11. The method of claim 1 wherein each of the semantic primitives is one of a binary semantic primitive and a symbolic-valued semantic primitive.

12. The method of claim 1 wherein the updating is performed only if the updating will result in all of the domain concepts in the updated table being uniquely characterized.

13. A system for creating and maintaining an ontology, the system comprising:
an output mechanism for transmitting a two dimensional table to a requestor, the table including domain concepts and semantic primitives related to a domain, wherein a data value in the table at an intersection of a domain concept and a semantic primitive indicates that the domain concept is characterized by the semantic primitive;
an input mechanism for receiving a command from the requestor to modify the table; and
a processor in communication with the input mechanism and the output mechanism and including instructions for facilitating:
updating the table in response to the command; and
storing the updated table as an ontology.

14. The system of claim 13 wherein the output mechanism further transmits a user interface screen for displaying the table to the requestor, wherein the command is transmitted by the requester via the requestor selecting an option on the user interface screen.

15. The system of claim 13 wherein the command indicates that a selected domain concept is characterized by a selected primitive and the updating includes adding the data value in the table at an intersection of the selected domain concept and the selected semantic primitive.

16. The system of claim 13 wherein the command includes adding one or more of a new domain concept and a new semantic primitive to the table.

17. The system of claim 13 wherein the ontology is compatible with a specialized ontology language.

18. The system of claim 13 wherein the instructions further facilitate importing the ontology into a specialized ontology development package.

19. A computer program product for creating and maintaining an ontology, the computer program product comprising:
a storage medium readable by a processing circuit and storing instructions for execution by the processing circuit for performing a method comprising:
transmitting a two dimensional table to a requester, the table including domain concepts and semantic primitives related to a domain, wherein a data value in the table at an intersection of a domain concept and a semantic primitive indicates that the domain concept is characterized by the semantic primitive;
receiving a command to modify the table from the requester;
updating the table in response to the command; and
storing the updated table as an ontology.
